(19) United States
(12) Patent Application Publication
(10) Pub. No.: US 2016/0275477 A1
(43) Pub. Date: Sep. 22, 2016

(54) METHOD AND SYSTEM FOR TRANSACTION VERIFICATION

(71) Applicant: Ouri Aharon Yosef SHIFMAN, Los Angeles, CA (US)

(72) Inventor: Ouri Aharon Yosef SHIFMAN, Los Angeles, CA (US)

(21) Appl. No.: 14/708,299

(22) Filed: May 11, 2015

Related U.S. Application Data
(60) Provisional application No. 62/133,726, filed on Mar. 16, 2015.

(51) Int. Cl. G06Q 20/32; H04W 4/02; G06Q 20/40

(52) U.S. Cl. CPC G06Q 20/3224; G06Q 20/401; G06Q 20/409; H04W 4/023

(57) ABSTRACT

Methods and systems allow for the verification of transactions, such as purchases, by location verification of the purchaser, for example, by obtaining the location of a device, such a mobile device, for example, a smartphone, of the purchaser.

### CROSS REFERENCES TO RELATED APPLICATIONS

This patent application is related to and claims priority from commonly owned U.S. Provisional Patent Application Ser. No. 62/133,726 filed on Mar. 16, 2015, entitled: METHOD AND SYSTEM FOR TRANSACTION VERIFICATION, the disclosure of which is incorporated by reference in its entirely herein.

### TECHNICAL FIELD

The present invention relates to methods and systems for verifyng transactions, such as purchases at sales outlets.

### SUMMARY OF THE DISCLOSED SUBJECT MATTER

The present invention includes embodiments that are directed to methods and systems which allow for the verification of transactions, such as credit card purchases, based on location verification.

Embodiments of the present invention are also directed to methods and systems that allow for the verification of transactions, such as purchases, by location verification of the purchaser. For example, the location is determined by obtaining the location of a device, such a mobile device, to example, a smartphone, of the purchaser.

This document references terms that are used consistently or interchangeably herein. Those terms, including variations thereof, are as follows.

The terms “click”, “clicks”, “click on”, “clicks on”, “activates”, and “activation”, involves the activation of a computer pointing apparatus, such as a device commonly known as a mouse, or a touch, swipe, or the like on a touch screen, on as location on a computer screen display, including screen displays of tablets and mobile telephones. The screen displays are activatable, for example, by an activatable icon, that causes an action of the various software and or hardware, including that for executing applications and supporting the computer screen display.

Throughout this document, a “web site” is a related collection of World Wide Web (WWW) files that includes a beginning file or “web page” called a home page, and typically, additional files or “web pages.” The term “web site” is used collectively to include “web site” and “web page(s).”

A uniform resource locator (URL) is the unique address for a file, such as a web site or a web page, that is accessible over Networks including the Internet.

“n” and “n^{th}” in the description below and the drawing figures represents the last member of a series or sequence of members, such as elements, servers, databases, caches, components, listings, links, data files, etc.

A “computer” includes machines, computers and computing or computer systems (for example, physically separate locations or devices), servers, computer and computerized devices, processors, processing systems, computing cores (for example, shared devices), and similar systems, workstations, modules and combinations of the aforementioned. The aforementioned “computer” may be in various types, such as a personal computer (e.g., laptop, desktop, tablet computer), or any type of computing device, including mobile devices that can be readily transported from one location to another location (e.g., smartphone, personal digital assistant (PDA), mobile telephone or cellular telephone).

A “server” is typically a remote computer or remote computer system, or computer program therein, in accordance with the “computer” defined above, that is accessible over a communications medium, such as a communications network or other computer network, including the Internet. A “server” provides services to, or performs functions for, other computer programs (and their users), in the same or other computers. A server may also include a virtual machine, a software based emulation of a computer.

HTML (Hypertext Markup Language) is the set of markup symbols or codes inserted in a file intended for display on a World Wide Web browser page.

Embodiments of the invention are directed to as method for obtaining and providing verification for transactions from users over a network. The method comprises: receiving an indication of a transaction made by a user at a location, over the network (or networks); determining whether the location of the transaction corresponds to the location of a device associated with the user making the transaction; and, confirming that the transaction is authorized based on the correspondence of the locations of the transaction and the device associated with user making the transaction.

Optionally, the method additionally comprises authorizing and completing the transaction in response to the confirming that the transaction is authorized.

Optionally, the transaction is a purchase transaction.

Optionally, the purchase transaction involves a credit or debit card provided by an issuer.

Optionally, the receiving an indication includes receiving data associated with at least one of a credit card or electronic payment.

Optionally, the determining whether the location of the transaction corresponds to the location of a device associated with the user making the transaction, includes determining whether the location of the transaction matches the location of the device associated with the user making the transaction.

Optionally, the device includes a smartphone and the location of the smartphone is determined by at least one of cell phone triangulation and geolocation.

Optionally, the transaction location is determined by a geolocation based on the data of the indication.

Optionally, the transaction location includes data for a location input by the user.

Optionally, the confirming that the transaction is authorized additionally comprises: determining whether a code received from the user matches a code corresponding to the user.

Optionally, the confirming that the transaction is authorized includes transmitting data of the authorization to the transaction location.

Embodiments of the present invention are also directed to a computer system for obtaining and providing verification for transactions from users over a network. The computer system comprises: a storage medium for storing computer components; and, a computerized processor for executing the computer components stored in the storage medium. The computer components comprise: a first component for receiving an indication of a transaction made by a user at a location, over the network; a second component for determining whether the location of the transaction corresponds to the location of a device associated with the user making the transaction; and a third component for confirming that the transaction is authorized based on the correspondence of the locations of the transaction and the device associated with user making the transaction.

Optionally, the computer system additionally comprises: a fourth component for authorizing and completing the transaction in response to the confirming that the transaction is authorized.

Optionally, the computer system additionally comprises: a payment administration system in communication with the first component, the second component and the third component.

Optionally, the payment administration system includes data for at least one of: credit cards, debit cards; and electronic payment services.

Optionally, the second component is configured for determining the location of the device associated with the user making the transaction.

Optionally, the computer system additionally comprises: a fifth component for prompting the user to enter a code on the device associated with the user, receiving a code inputted by the user to the device associated with the user, and determining whether the code received from the device associated with the user matches a code corresponding to the user.

Still other embodiments of the present invention are directed to a computer-usable non-transitory storage medium having a computer program embodied thereon for causing a suitable programmed system to provide verification for transactions from users over a network, by performing the following steps when such program is executed on the system. The steps comprise: receiving an indication of a transaction made by a user at a location, over the network; determining whether the location of the transaction corresponds to the location of a device associated with the user making the transaction; and, confirming that the transaction is authorized based on the correspondence of the locations of the transaction and the device associated with user making the transaction.

Optionally, the steps additionally comprise: authorizing and completing the transaction in response to the confirming that the transaction is authorized.

Optionally, the step of confirming the transaction includes prompting the user to enter a code on the device associated with the user, receiving a code inputted by the user to the device associated with the user, and determining whether the code received from the device associated u oh the user matches a code corresponding to the user.

Unless otherwise defined herein, all technical and/or scientific terms used herein have the same meaning as commonly understood by one of ordinary skill in the art to which the invention pertains. Although methods and materials similar or equivalent to those described herein may be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF DRAWINGS

Some embodiments of the present invention are herein described, by way of example only, with reference to the accompanying drawings. With specific reference to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

Attention is now directed to the drawings, where like reference numerals or characters indicate corresponding or like components. In the drawings:

FIG. 1A-1 is a diagram of an exemplary environment for the system in which embodiments of the disclosed subject matter are performed;

FIG. 1A-2 is a diagram of an exemplary environment for an alternative system in which embodiments of the disclosed subject matter are performed;

FIG. 1B is a diagram of the architecture of the system;

FIG. 1C is a diagram of a database associated with a user of the system;

FIGS. 2A, 2B-1 and 2B-2 are diagrams of the systems of FIGS. 1A-1 and 1A-2 which detail transactions and verifications thereof in accordance with embodiments of the present invention;

FIGS. 3A and 3B are a flow diagram of processes in accordance with embodiments of the present invention;

FIG. 4 is a screen shot or screen diagram that appears on the monitor of the device, such as a cell phone (smartphone), of the user making an example purchase at a registered location, as shown in FIG. 2A; and,

FIGS. 5A to 5C are screen shots or screen diagrams that appear on the monitor of the device, such as the cell phone (smartphone), of the user making an example purchase at an unregistered location, as shown in FIGS. 2B-1 and 2B-2.

### DETAILED DESCRIPTION OF THE DRAWINGS

Before explaining at least one embodiment of the invention in detail, it is to be understood that the invention is not necessarily limited in its application to the details of construction and the arrangement of the components and/or methods set forth in the following description and/or illustrated in the drawings. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more non-transitory computer readable (storage) medium(s) having computer readable program code embodied thereon.

Throughout this document, numerous textual and graphical references are made to trademarks, and domain names. These trademarks and domain names are the property of their respective owners, and are referenced only for explanation purposes herein.

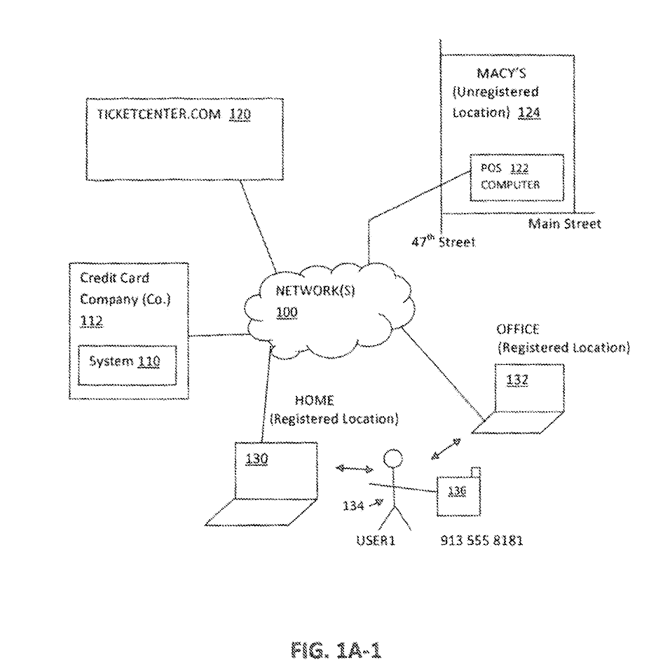

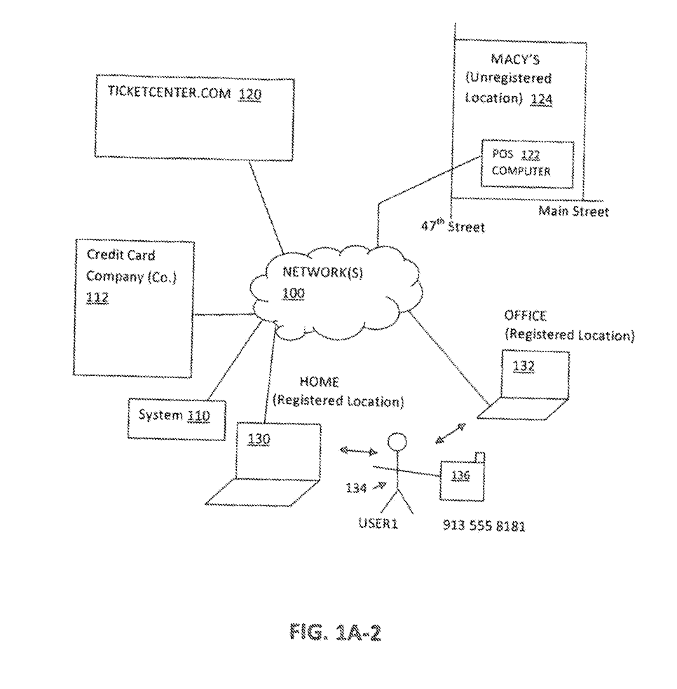

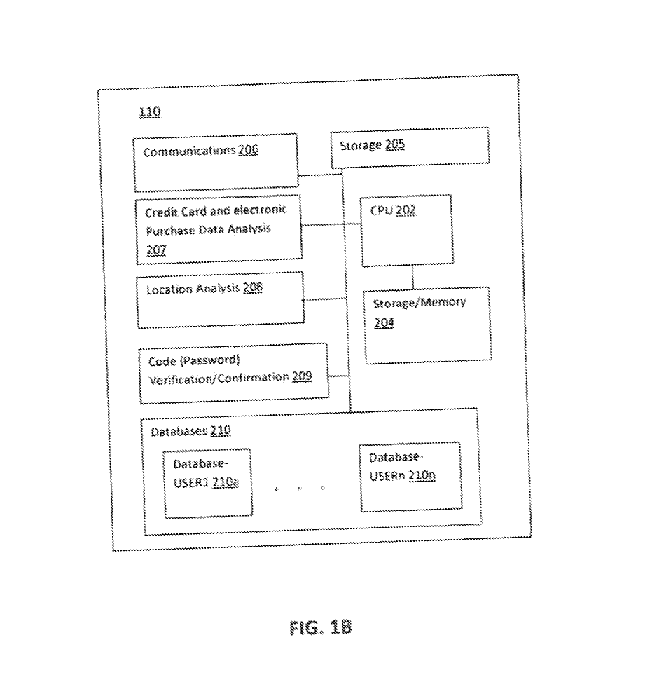

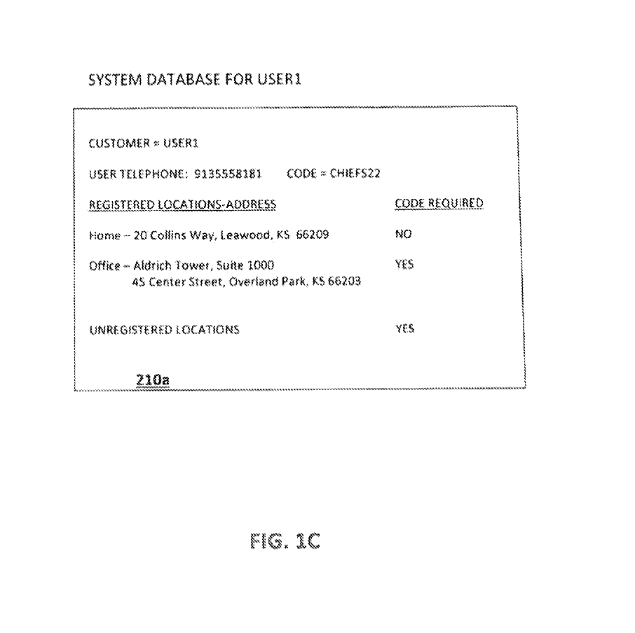

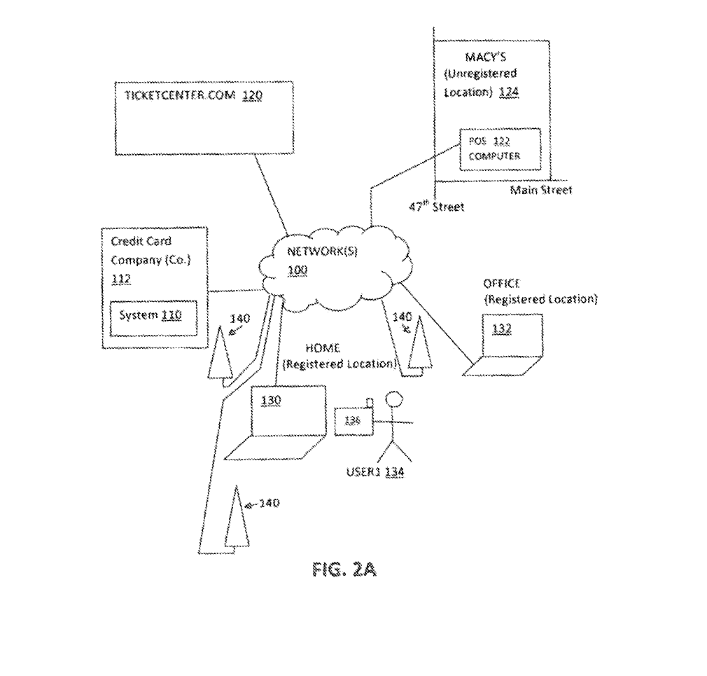

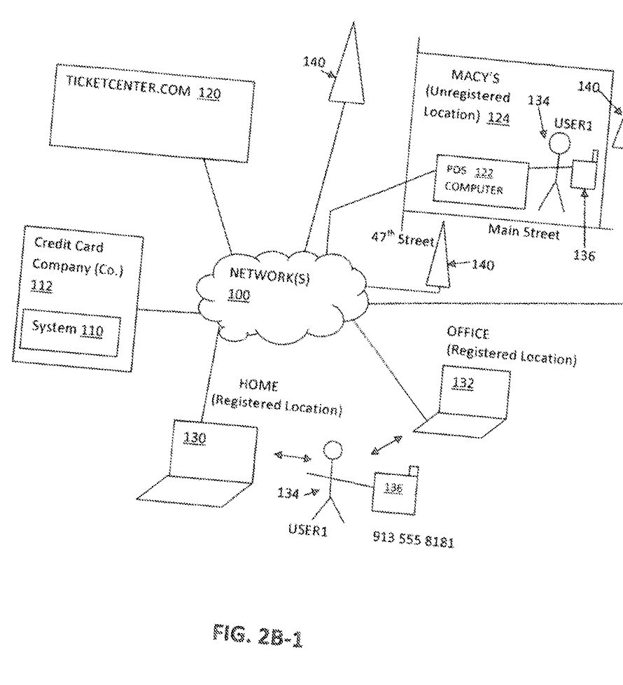

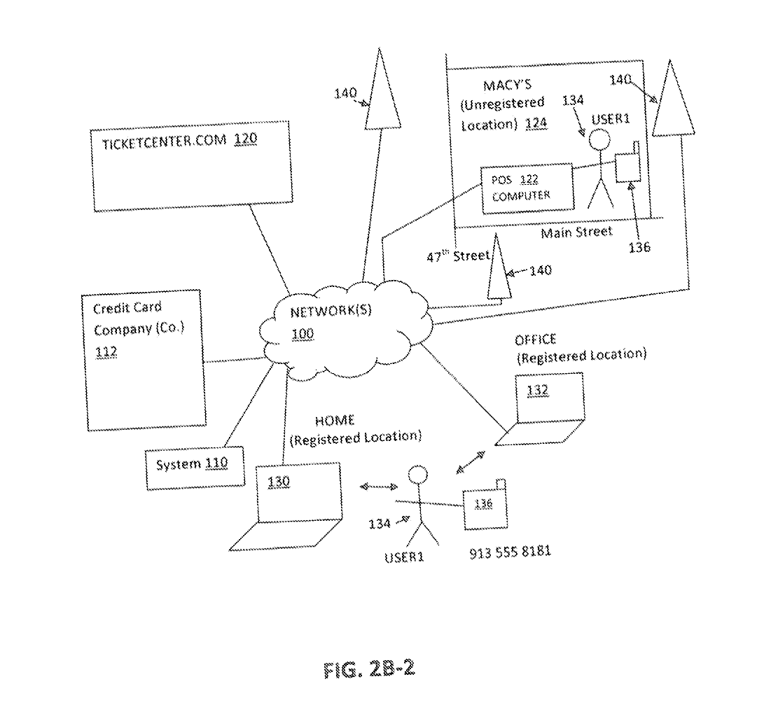

Reference is now made to FIGS. 1A-1, 1A-2, 1B and 1C. FIG. 1A-1 shows an exemplary operating environment. The environment includes a network 100, to which is linked a system 110 which performs the methods of the present invention. The system 110, for example, is a computer system, formed of computers, servers, other computerized components and the like, and typically resides among the computers, servers, and the like, also linked to the network 100, of a Credit Card Company (Co.) 112 (throughout this document, except where specifically indicated, “Credit Card Company” and “Credit Card Company Server” are used interchangeably).

FIG. 1A-2 shows an alternative environment, where the system 110 is separate from the credit card company. The credit card company is represented by the credit card company server 112. The server representative of the system 110 is positioned along the network 100 and linked thereto.

In both environments of FIGS. 1A-1 and 1A-2, also linked to the network 100 are servers, computers, and the like, representative of multiple servers, computers and the like, which may link to the network 100, including a third party server 120 of the entity, Ticketcenter.com of the URL, www.ticketcenter.com (a seller of event tickets), and a point of sale (POS) computer/server 122 of a retailer 124 (e.g., Macys® department store. known as “Macy's,” at 47^{th} Street and Main Street in Kansas City, Mo. 64123), which reads credit cards and transmits this credit card information over the network 100 to the system 110 at the credit card company 112 (FIG. 1A-1) and to the system 110, either through the credit card company server 112, or directly (FIG. 1A-2).

The Home Computer 130 and Office Computer 132, as shown, are associated with a user 134, e.g., USER1 (as shown by the double headed arrows), are also linked to the network 100. The user, e.g., USER1 134, also has a communication device, for example, a smartphone 136, with the phone number 913.555.8181, which links to the network 100, for example, via cellular towers 140 (FIGS. 2A, 2B-1 and 2B-2), WIFI®, and combinations thereof, and receives and transmits communications, for example, in forms such as voice communications, texts, and other commonly available forms of smartphone communication.

The network 100 is, for example, a communications network, such as a Local Area Network (LAN), or a Wide Area Network (WAN), including public networks such as the Internet. As shown in FIGS. 1A-1, 1A-2, 2A, 2B-1 and 2B-2, the network 100 is, for example, the Internet. The network 100, although shown as a single network, may be a combination of networks and/or multiple networks including, for example, cellular networks. “Linked” as used herein includes both wired or wireless links, either direct or indirect, and placing the computers, including, servers, components and the like, in electronic and/or data communications with each other.

The system 110, including its servers, computers, computer components and the like (collectively “servers of the system 110”) are programmed a perform the processes in accordance with embodiments of the invention. The servers of the system 110 include processors, such as those used for “Big Data”, and are linked to storage/memory for supplying machine executable instructions to be executed by the processors. The servers of the system 110 are also programmed to transmit communications which are data, radio signals, and the like, to be used on both computer and cellular networks, and combinations thereof, for example, to send and receive communications from smartphones such as voice communications, texts, short message service (SMS), e-mail, communications from other servers linked to the network, and the like. All components of the system 110, and its servers can use hosted services over the cloud.

FIG. 1B shows a diagram of an architecture for the system 110. The architecture includes one or more components, engines, modules and the like, for operating the present invention. The most germane components of the invention are shown and described, but numerous components, engines and modules are permissible.

The system 110 includes a central processing unit (CPU) 202 formed of one or more processors, electronically connected, including in electronic and/or data communication with components, including, for example, storage/memory 204, storage media 205, a communications module 206, a credit card and electronic data purchase module 207, a location analysis module 208, a code verification/confirmation module 209, and databases 210, including a database 210a for the customer (user) USER1 134. The databases 210 are accessible, for example, by system administrators, as well as customers (users) of the system 110.

The Central Processing Unit (CPU) 202 is formed of one or more processors, including microprocessors, for performing the system 110 functions and operations detailed herein, including controlling the storage media 205, and modules 206-209. The processors are, for example, conventional processors, such as those used in servers, computers, and other computerized devices, including those used in “big data” processing. For example, the processors may include x86 Processors from AMD and Intel, Xenon® and Pentium® processors from Intel, as well as an combinations thereof.

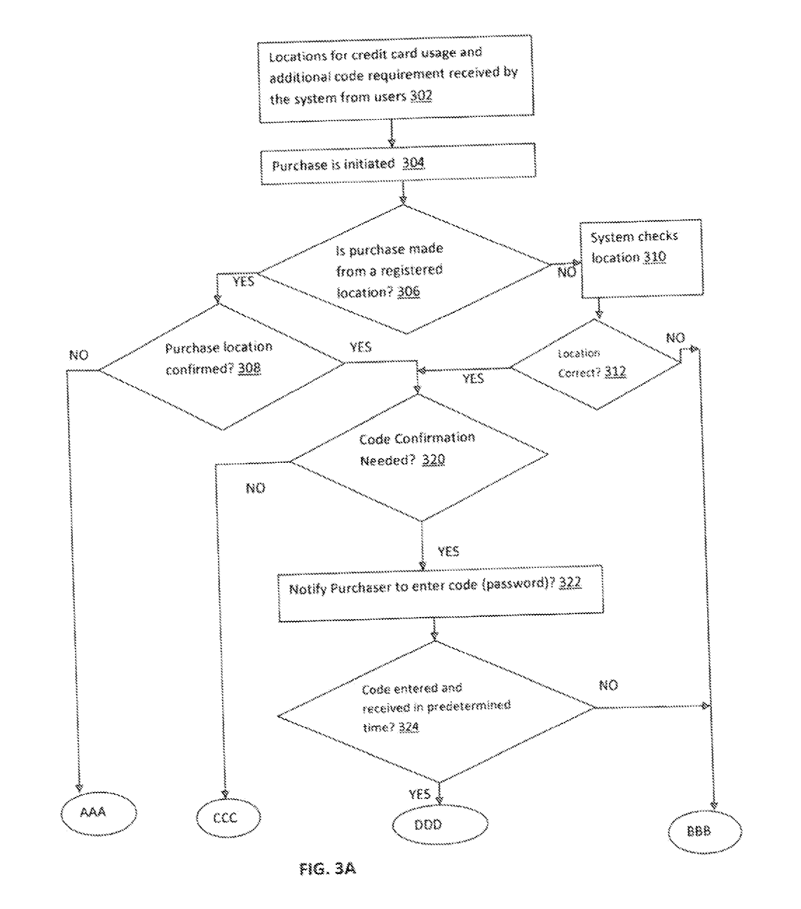

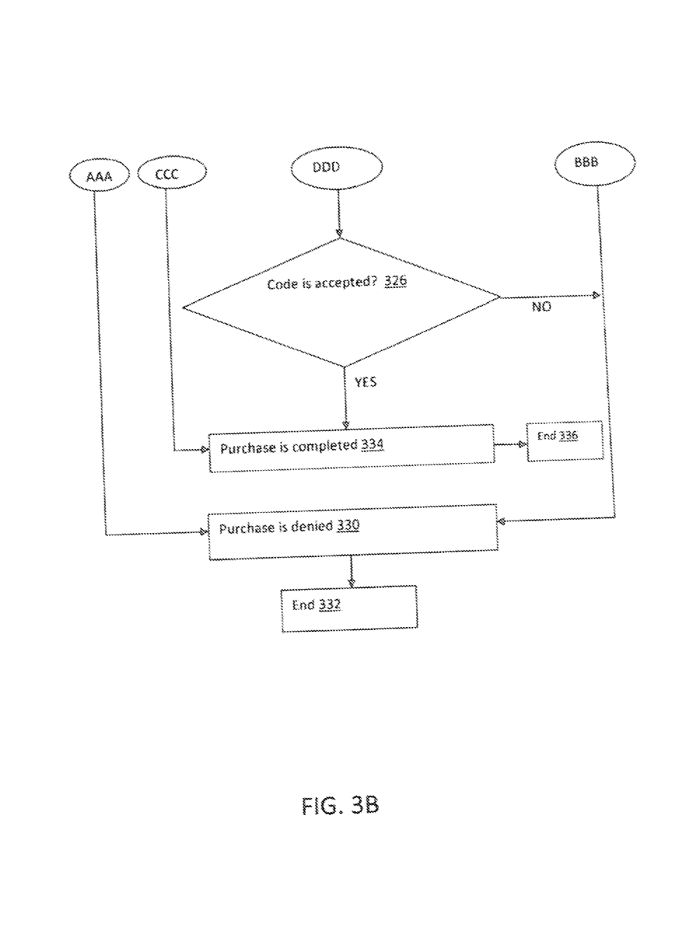

The storage/memory 204 is any conventional storage media. The storage/memory 204 stores machine executable instructions for the CPU 202 associated with the operation of the components, including storage media 205, modules 206-209, and databases 210, as well as instructions for executing the processes of FIGS. 3A and 3B. The processors of the CPU 202 and the storage/memory 204, although shown as a single component for representative purposes, may be multiple components, and may be outside of the system 110, and linked to the network 100.

There is also additional storage media 205 for storing various data, associated with the processes performed by the system 110.

The communications module 206 stores instructions for, and handles, processing of all data and cellular communications that enter and are transmitted from the system 110. The data which is received by the system 110 includes, for example, data from retailers and other sources of credit card or other electronic payment data, data from web sites and web pages, codes, passwords, PINs (Personal Identification Number), other access data (hereinafter collectively referred to as “a code”), as provided by the system 110, as well as transmitted to the system 110 from users, such as codes entered in texts, emails, voice and other cellular communications. This module 206 also handles transmissions from the system 110 of data and cellular communications, such as purchase authorization data in data transmissions over the network 100 to retailers and other purchase sources, and cellular communications to purchasers indicating, for example, that their purchase has been verified and/or confirmed, and they entered a valid code.

The credit card and electronic data purchase module 207 coordinates and administers the credit card data with the various retailers and other sources of payment data.

The location analysis module 208 provides instructions to the CPU for analyzing locations, both registered and unregistered, as coordinates, or other values and data, for systems such as cellular triangulation and Global Positioning Systems (GPS). This module 208 also includes instructions for, and handles, comparing the stored and known location of the purchase, to the locations of the requisite user's cellular phone or smartphone, to determine if the purchase location and the phone location match, to allow the purchase to be verified and confirmed.

The code verification/confirmation module 209, includes instructions for, and handles, analyzing, for example, comparing, the received codes, inputted by users upon being prompted to do so, against the code(s) stored in the databases 210 for the users. This module 209 then signals the communication module 206 to send the requisite notification to the credit card company 112 and optionally, the customer (e.g., user 134).

The databases 210 store data associated with the customers (users) for the system, for example, holders of the credit card of credit card company 112. Database 210a is representative of the databases for the customers (users). For example, looking at the database 210a for the customer (user) USER1 134, USER1 134 has provided the telephone number of his smartphone 136 (913.555.8181) to be used by the system 110, as well as registered locations front which he frequently makes purchases, e.g., HOME and the OFFICE, and has provided their address, known as location information. This address (location information) is expressed as coordinates or other values or data by location services such as cellular triangulation, global positioning systems (GPS) and the like. The user 134 has also provided the system with the requirement that a code must be entered, as well as with a personal code or password (e.g.. CHIEFS22) to be entered when prompted by the system 110 during a purchase transaction.

FIG. 2A shows the user, e.g. USER1 134, making a purchase at a registered location, e.g., ticketcenter.com 120, at his HOME, the registered location, on his home computer 130. The system 110 is in data and cellular communications with the smartphone 136 of the user 134. The location of the user 134, is obtained or determined, via the network, for example, by triangulation of the smartphone 136 of the user 134 from a “triangle” of typically the three closest cellular towers 140 to the smartphone 136.

FIGS. 2B-1, and 2B-2 show the user, e.g. USER1 134, making a purchase at an unregistered location, a retailer, e.g., Macys 124. The credit card of the user 134 is run through the POS computer 122 with the credit card data transmitted, e.g., sent, to the system 110 of the credit card company 112 over the network 100 (FIG. 2B-1), or to the system 110, directly, or via the credit card company server 112 (FIG. 2B-2). The system 110 is in electronic communication, for example, data and cellular communication, with the smartphone 136 of the user 134. The location of the user 134 at Macy's 124, is obtained or determined, for example, via the network 100, for example, by triangulation of the smartphone 136 of the user 134 from the cellular towers 140.

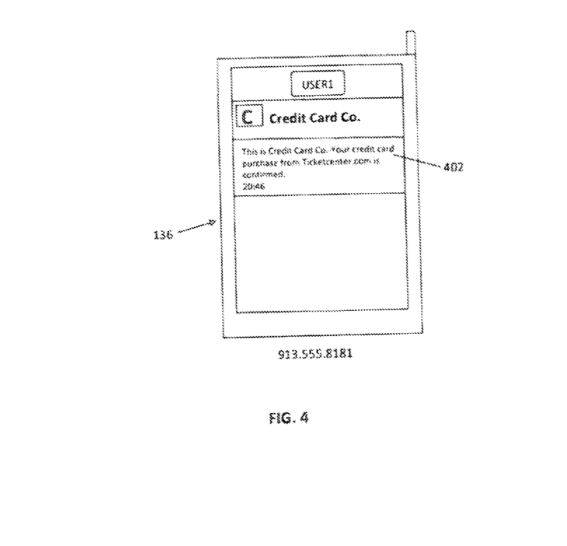

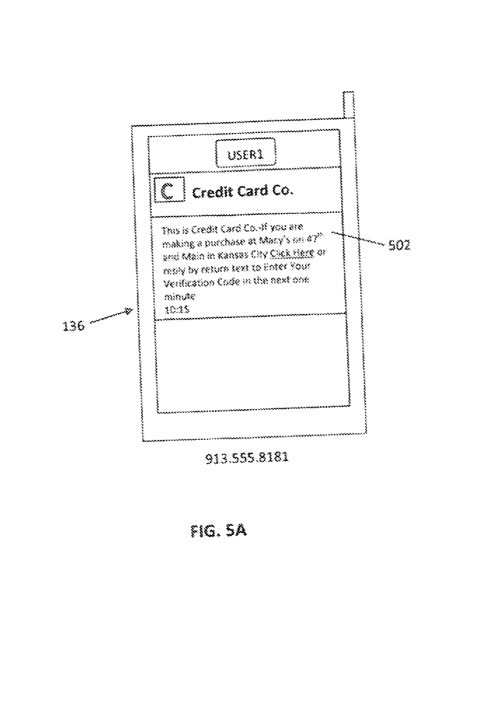

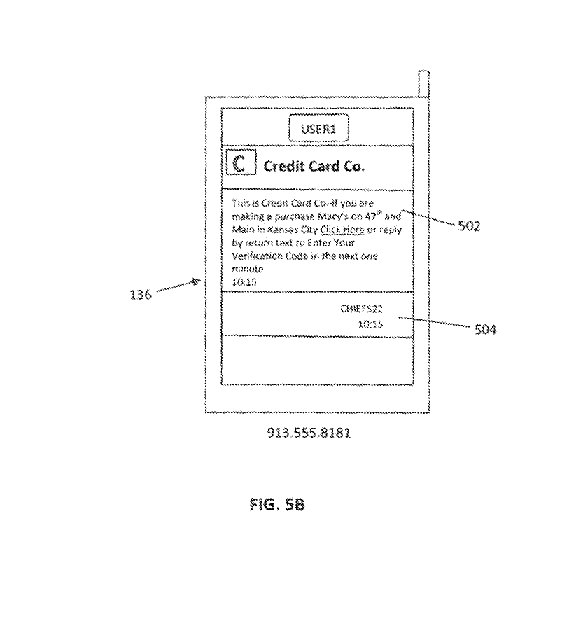

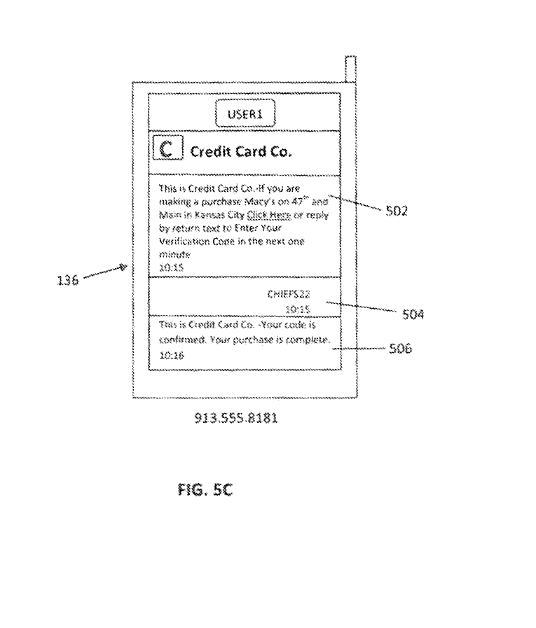

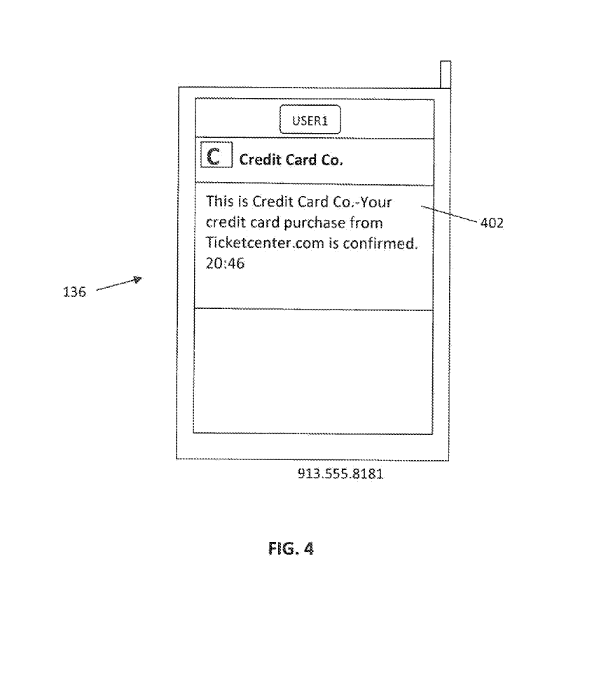

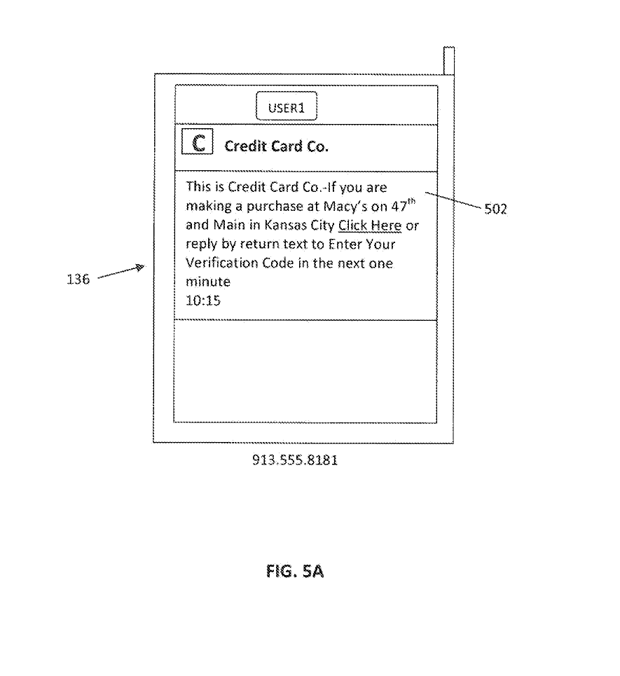

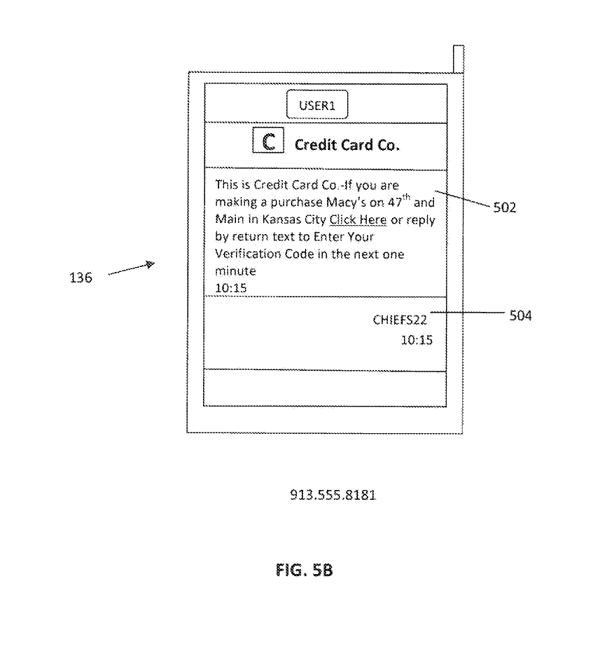

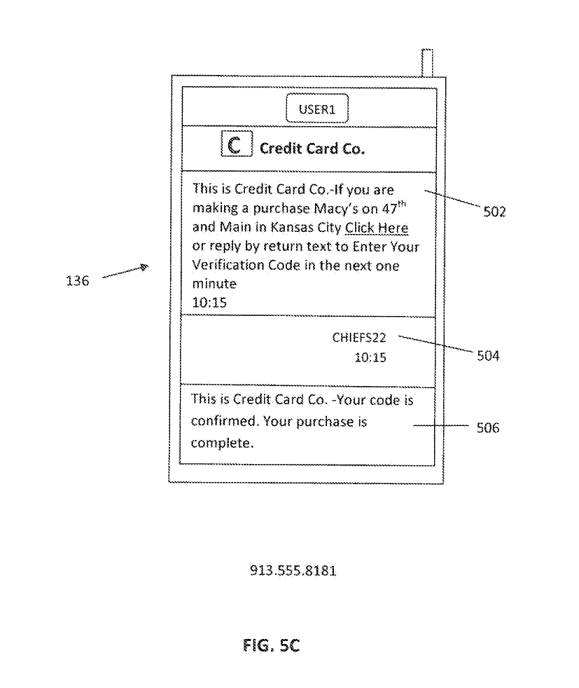

Attention is now directed to FIGS. 3A and 3B which show a flow diagram detailing a computer-implemented process in accordance with embodiments of the disclosed subject matter as performed in the environments of FIGS. 1A-1, 1A-2, 2A, 2B-1 and 2B-2, by, for example, a user, e.g., USER1 134 performing a transaction, such as making a purchase at a vender, retailer, seller or the like. Reference is also made to elements shown in FIGS. 1B, and 1C. When the process is different in the alternative environments of FIGS. 1A-2 and FIG. 2B-2, this is indicated with specific reference to FIGS. 1A-2, and 2B-2 or the “alternative embodiment.” The process and subprocesses of FIGS. 3A and 3B are computerized processes performed by the system 110. The aforementioned processes and sub-processes can be, for example, performed manually, automatically, or a combination thereof and, for example, in real time. Reference is also made to the screen shots of FIGS. 4 and 5A-5C, which appear on screen (or display) of, for example, the device, of the user, for example, the smartphone 136 of USER1 134, the user, when describing the process of FIGS. 3A and 3B, as detailed below.

FIGS. 3A and 3B are a process for making and verifying transactions, such as purchase transactions made with credit cards, debit cards or other electronic data and payment systems, such as Apple® Pay™, transmittable over networks, with the verification and purchase confirmation occurring after a location confirmation of the purchaser, for example, via the location of his smartphone, is made.

At block 302, the system 110 has received and populated a database in the databases 210, data from a customer (user) indicating Name, a telephone number for the smartphone whose location will be monitored by the system 110, a code. Password, PIN (Personal Identification Number), other access data (hereinafter collectively referred to as “a code”), purchase locations (with addresses, e.g., location data) to be registered, an option selection to determine if a code (password) is required in addition to the location confirmation, and an entry for unregistered purchase locations, whether is code entry is required.

The process moves to block 304, where the system 110 receives data, for example, as part of an electronic indication, that a transaction, e.g., purchase, is being initiated with the Credit Card Company's 112 credit card or other electronic purchase data, or other credit card processed by the Credit Card Company 112. This electronic indication is transmitted by the vender, retailer, seller, e.g., the server which hosts the URL www.ticketcenter.com 120, or a point of sale (POS) computer, to the system 110. The vender, retailer, seller or POS Computer, for example, processes the credit card or other electronic form of payment, such as Apple® Pay™, or the like. A POS computer is represented, for example, by the POS computer 122 at Macy's Department Store 124 (with a physical location of 47^{th} Street and Main Street, Kansas City, Mo. 64123).

Alternately, the system 110, when separate from the credit card server 112, in the alternative environments of FIGS. 1A-2, and 2B-2, receives the indication as transmitted from 1) the credit card company server 112, which has received data including at least the indication from the vender, retailer, seller, POS computer, that a transaction has been initiated, or, 2) vender, retailer, seller, e.g., the server for www.ticketcenter.com 120, or a point of sale (POS) computer the POS (without going through the credit card company server 112). The indication includes data of the transaction itself, the user (entity) making the transaction, as well as the credit card data associated therewith. Alternately, when the indication, with at least some user data, is transmitted from the vender, retailer, seller, e.g., the server for www.ticketcenter.com 120, or a point of sale (POS) computer POS to the system 110, the system 110 may then transmit this data, to the credit card company server 112, in order to obtain all necessary information about the user and the credit card, in order to complete the confirmation or deny the transaction (as detailed below).

The process now moves to block 306, where the system 110, for example, at module 207, analyzes the credit card data transmitted, e.g., sent from the vender, retailer, seller, and/or POS, or the credit card server 112 (FIGS. 1A-2 and 2B-2). This analysis is performed to determine, from the credit card data, for example, the user, e.g., person or entity, making the transaction, for example, the purchase, location of the purchase, the vending retailing, selling or point of transaction (e.g., sale) sale entity (collectively, the location of the transaction, e.g., purchase), and whether the location of transaction, e.g., the purchase, is a registered location in the database 210 of the system 110 for the user 134.

If the location of the purchase is registered with the system 110, a purchase location confirmation process is performed at block 308. The registered location of the purchase is compared with the location of the device 136, e.g., smartphone 130, tablet computer, such as an ipad®, of or associated with the user 134. The system 110 determines, or otherwise obtains, the location of the device, e.g., the smartphone 136 by processes such as cell phone triangulation, via cellular towers 140, geolocation, and the like. Alternately should the device be a computer, such as a desktop computer, laptop computer, or the like, the system 110 can locate the computer by conventional methods over the network 100, such as IP (Internet Protocol) address.

At block 308, if there not a match, according to the stored rules and policies in the location analysis module 208, the purchase location is not confirmed. The process moves to block 330 where the purchase is denied. The credit card company 112 (for example, via the communications module 206 of the system 110) transmits data to the retailer (vender) indicating that the purchase is denied, and the user is notified by the retailer (vender) and/or the credit card company 112 (e.g., system 110), that the purchase was denied. The process moves to block 332 where it ends.

Alternately, with the environments of FIGS. 1A-2 and 2B-2, the system 110 transmits this information of the denial to the credit card company server 112, which in turn, transmits data to the retailer (vender), e.g., Macy's 124 at 47^{th} Street and Main Street, indicating that the purchase is denied, and the user is notified by the retailer (vender) and/or the credit card company 112, that the purchase was denied. As another alternative, the system 110, for example, via the communications module 206, transmits data to the retailer (vender) e.g., Macy's 124, indicating that the purchase is denied, and the system 110 notifies the user 134 retailer (vender) and/or the credit card company 112, that the purchase was denied, and the process moves to blocks 330 and 332, as detailed immediately above.

At block 308, should the locations of the registered location and device, e.g., smartphone or computer, location match, the purchase location is confirmed, and the process moves to block 320.

Returning to block 306, should the purchase be made at an unregistered location, the process moves to block 310. Here, the system 110 checks and obtains the geographic or physical location of the unregistered location, for example, by geolocation systems such as Global Positioning Systems (GPS), Google® Maps®, and the like, where the purchase was made, from, for example, the credit card data which it received, as detailed above.

The process moves to block 312, were the system 110 determines whether the purchase location is correct—whether the location of the unregistered location matches the location of the device, e.g., smartphone or computer, of or otherwise associated with the user 134. This is performed by the system 110 comparing the unregistered location of the purchase to the location of the device, smartphone 136, of the user 134, this smartphone location having been determined by processes such as cell phone triangulation, as detailed above. Should the locations not match, the location is incorrect, and the process moves to block 330 where the purchase is denied. The credit card company server 112 (for example, via the communications module 206 of the system 110) transmits data to the retailer indicating that the purchase is denied, and the use is notified by the retailer and/or the credit card company 112, that the purchase was denied. The process then moves to block 332 where it ends.

Alternately, for the environments of FIGS. 1A-2 and 2B-2, the system 110, for example, via the communications module 206, transmits this information of the denial to the credit card company server 112, which in turn transmits data to the retailer, e.g., Macy's 124, indicating that the purchase is denied, and the user is notified by the retailer, credit card company 112, and/or the system 110, that the purchase was denied. The process moves to blocks 330 and 332, as detailed immediately above.

Should the locations match, the location is correct, at block 312, and the process moves to block 320.

Attention is now directed to block 320. The process is now the same for both registered and unregistered locations. At block 320, the system 110 checks the database(s) 210 for the user, to see whether an additional code (password) to be input (entered) by the user is needed.

Should a code not be needed at block 320, the process moves to block 334, where the purchase is completed. For example, the system 110 notifies the user 134, e,g., the purchaser, for example, by transmitting a text to the smartphone 136, for example, via the communications module, that the purchase (for example, using the credit card of the credit card company 112) is verified and complete.

In the environments of FIGS. 1A-2 and 2B-2, the credit card company 112 is also notified, by the system 110, for example, via the communications module 206, that the transaction is authentic and therefore, verified. The system 110, for example, via the communications module 206 and/or the credit card company 112 transmits data, informing the retailer and/or the user of this verification, so that the transaction, e.g., purchase, can be completed, as the process moves to block 334.

Block 334 is shown for example, in FIGS. 2A and 4, where USER1 134 has completed a purchase at Ticketcenter.com 120, using his credit card issued by the credit card company 112, front his HOME, a registered location, in the database 210a for USER1 134, USER1 134, on his device, e.g., smartphone 136, has received a text message 402 confirming his purchase from Ticketcenter.com 120.

From block 334, the process moves to block 336, where it ends.

Should a code be required at block 320 (e.g., the user/purchaser must enter a code to complete the transaction), the process moves to block 322, where the system 110 notifies or prompts the user making the purchase, to enter (input) his code into the device 136. The code may be entered, for example, via a return text, via a web site (e.g., an HTML link, “Click Here,” to the web site), or even by calling the credit card company 112 (or the system 110, which then notifies the credit card company 112, by a transmission of such data over the network (for example, from the communications module 206), with the environment of FIGS. 1A-2 and 2B-2). For example, as shown in FIG. 5A, with a purchase from Macy's 124, an unregistered location, the user has received a text message (also known as a “text”) 502 from the credit card company 112 indicating that he is making a purchase at Macy's and he needs to enter (input) his code to keep the purchase transaction alive.

The process moves to block 324, where it is determined by the system 110, whether the code is received in a set time period, for example, one minute. Should a code not be received in the time period, for example, there is a “Time Out”, and accordingly, the process moves to block 330, where the purchase is denied. The process then moves to block 332, where the process ends, as detailed above.

However, at block 324, should the system receive a code, as input by the user, within the time period, e.g., one minute, for example, in a return text 504, as shown in FIG. 5B, the process moves to block 326.

At block 326, the system 110, for example, module 209, analyzes the code which was input by the user, and determines whether it is acceptable—did the code entered by the user match the stored code (in the database 210) for the user 134. This stored code may be for example, a code input by the user for storage, or assigned by the system 110 and provided to the user 134. Should the codes not match, the process moves to block 330, where the purchase is denied, and block 332, where the process ends, as detailed above.

Should the codes match, at block 326, the code received from the user 134 is accepted, and the process moves to block 334. For example, the code “CHIEFS22” in the return text 504 (FIG. 5B), matched the stored code “CHIEFS22” in the database 210a for USER1 134.

At block 334, the transaction, e.g., purchase, is verified, confirmed and now completed. The system 110 and/or the credit card company 112 tin the environments of FIGS. 1A-2 and 2B-2), can provide notification to the device, e.g., smartphone 136, of the user 134, that the transaction e.g., purchase, is complete. This is shown, for example in FIG. 5C, where USER1 has received a text 506 indicating completion of the purchase from MACY's on his smartphone 136. The process now ends at block 329.

While a transaction in the form of a purchase has been shown, this is exemplary only. The disclosure above is applicable for numerous transactions which require or need verification based on location of a user, customer, recipient, consumer, provider, or the like.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions.

Optionally, the data processor includes a volatile memory for storing instructions and/or data and/or a non-volatile storage, for example, non-transitory storage media such as a magnetic hard-disk and/or removable media, for storing instructions and/or data Optionally, a network connection is provided as well. A display and/or a user input device such as a keyboard or mouse are optionally provided as well.

For example, any combination of one or more non-transitory computer readable (storage) medium(s) may be utilized in accordance with the above-listed embodiments of the present invention. The non-transitory computer readable (storage) medium may be a computer readable signal medium or a computer readable storage medium. A computer readable storage medium may be, for example, but not limited to, an electronic, magnetic, optical , electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, as random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing,. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

As will be understood with reference to the paragraphs and the referenced drawings, provided above, various embodiments of computer-implemented methods are provided herein, some of which can be performed by various embodiments of apparatuses and systems described herein and some of which can be performed according to instructions stored in non-transitory computer-readable storage media described herein. Still, some embodiments of computer-implemented methods provided herein can be performed by other apparatuses or systems and can be performed according to instructions stored in computer-readable storage media other than that described herein, as will become apparent to those having skill in the art with reference to the embodiments described herein. Any reference to systems and computer-readable storage media with respect to the following computer-implemented methods is provided for explanatory purposes, and is not intended to limit any of such systems and any of such non-transitory computer-readable storage media with regard to embodiments of computer-implemented methods described above. Likewise, any reference to the following computer-implemented methods with respect to systems and computer-readable storage media is provided for explanatory purposes, and is not intended to limit any of such computer-implemented methods disclosed herein.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block, of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the singular form “a”, “an” and “the” include plural references unless the context clearly dictates otherwise.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

The above-described processes including portions thereof can be performed by software, hardware and combinations thereof. These processes and portions thereof can be performed by computers, computer-type devices, workstations, processors, micro-processors, other electronic searching tools and memory and other non-transitory storage-type devices associated therewith. The processes and portions thereof can also be embodied in programmable non-transitory storage media, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A method for obtaining and providing, verification for transactions from users over a network, comprising:
receiving an indication of a transaction made by a user at a location, over the network;
determining whether the location of the transaction corresponds to the location of a device associated with the user making the transaction; and,
confirming that the transaction is authorized based on the correspondence of the locations of the transaction and the device associated with user making the transaction.

2. The method of claim 1, additionally comprising, authorizing and completing the transaction in response to the confirming that the transaction is authorized.

3. The method of claim 2, wherein the transaction is a purchase transaction.

4. The method of claim 3, wherein the purchase transaction involves a credit or debit card provided by an issuer.

5. The method of claim 1, wherein the receiving an indication includes receiving data associated with at least one of a credit card or electronic payment.

6. The method of claim 1, wherein the determining whether the location of the transaction corresponds to the location of a device associated with the user making the transaction, includes determining whether the location of the transaction matches the location of the device associated with the user making the transaction.

7. The method of claim 6, wherein the device includes a smartphone and the location of the smartphone is determined by at least one of cell phone triangulation and geolocation.

8. The method of chum 7, wherein the transaction location is determined by geolocation based on the data of the indication.

9. The method of claim 7, wherein the transaction location includes data for a location input by the user.

10. The method of claim 1, wherein confirming that the transaction is authorized additionally comprises: determining whether a code received from the user matches a code corresponding to the user.

11. The method of claim 1, wherein the confirming that the transaction is authorized includes transmitting data of the authorization to the transaction location.

12. A computer system for obtaining and providing verification for transactions from users over a network, comprising:
a storage medium for storing computer components; and,
a computerized processor for executing the computer components stored in the storage medium, comprising:
a first component for receiving an indication of a transaction made by a user at a location, over the network;
a second component for determining whether the location of the transaction corresponds to the location of a device associated with the user making the transaction; and,
a third component for confirming that the transaction is authorized based on the correspondence of the locations of the transaction and the device associated with user making the transaction.

13. The computer system of claim 12, additionally comprising: a fourth component for authorizing and completing the transaction in response to the confirming that the transaction is authorized.

14. The computer system of claim 12, additionally comprising: a payment administration system in communication with the first component, the second component and the third component.

15. The computer system of claim 14, wherein the payment administration system includes data for at least one of: credit cards, debit cards; and electronic payment services.

16. The computer system of claim 15, wherein the second component is configured for determining the location of the device associated with the user making the transaction.

17. The computer system of claim 16, additionally comprising: a fifth component for prompting the user to enter a code on the device associated with the user, receiving a code inputted by the user to the device associated with the user, and determining whether the code received from the device associated with the user matches a code corresponding to the user.

18. A computer-usable non-transitory storage medium having a computer program embodied thereon for causing a suitable programmed system to provide verification for transactions from users over a network, by performing the following steps when such program is executed on the system, the steps comprising:
receiving, an indication of a transaction made by a user at a location, over the network;
determining whether the location of the transaction corresponds to the location of a device associated with the user making the transaction; and,
confirming that the transaction is authorized based on the correspondence of the locations of the transaction and the device associated with user making the transaction.

19. The computer-usable non-transitory storage medium of claim 18, wherein the steps additionally comprise: authorizing and completing the transaction in response to the confirming that the transaction is authorized.

20. The computer-usable non-transitory storage medium of claim 18, wherein the step of confirming the transaction includes prompting the user to enter a code on the device associated with the user, receiving a code inputted by the user to the device associated with the user, and determining whether the code received from the device associated with the user matches a code corresponding to the user.
